(19) United States
(12) Patent Application Publication
(10) Pub. No.: US 2024/0141180 A1
(43) Pub. Date: May 2, 2024

(54) Pigmented Aqueous Coating Composition with Improved Stability Towards Pinholes

(71) Applicant: BASF COATINGS GMBH, Münster (DE)

(72) Inventors: Norbert LOEW, Wuerzburg (DE); Bastian BLUM, Münster (DE); Michael KAEMMERER, Wuerzburg (DE); Bernhard STEINMETZ, Münster (DE); Florian SCHAEFFER, Wuerburg (DE)

(21) Appl. No.: 17/754,901

(22) PCT Filed: Oct. 23, 2020
(86) PCT No.: PCT/EP2020/079852

§ 371 Date: Apr. 15, 2022

(30) Foreign Application Priority Data
Oct. 23, 2019 (EP) 19204851.0

(51) Int. Cl. C09D 7/41; B05D 1/36; C08J 7/04; C09D 7/61; C09D 7/63; C09D 133/12; C09D 167/00; C09D 175/04

(52) U.S. Cl. CPC C09D 7/41; B05D 1/36; C08J 7/042; C09D 7/61; C09D 7/63; C09D 133/12; C09D 167/00; C09D 175/04; B05D 2201/00; B05D 2202/00

(57) ABSTRACT

Disclosed herein is a pigmented aqueous coating composition including at least one binder, at least one mono-, di- and/or triglyceride, and at least one silica compound. Further disclosed herein is a method for producing a multicoat paint system by producing a basecoat or two or more directly consecutive basecoats directly on a substrate optionally coated with a first coat, producing a clearcoat directly on the basecoat or on the topmost of the two or more basecoats, and then jointly curing the one or more basecoats and the clearcoat. At least one of the basecoat materials includes the aqueous coating composition disclosed herein. Additionally disclosed herein is a multicoat paint system obtainable by the disclosed method.

The present invention relates to a pigmented aqueous coating composition comprising at least one binder, at least one mono-, di and/or triglyceride, and at least one silica compound. The present invention further relates to a method for producing a multicoat paint system by producing at least one basecoat directly on a substrate optionally coated with a first coat, producing a clearcoat directly on the topmost basecoat layer, and then jointly curing the at least one basecoat and the clearcoat. At least one of the basecoat materials comprises the aqueous coating composition of the invention. Finally, the present invention relates to a multicoat paint system obtainable by the method of the invention.

### STATE OF THE ART

In automotive finishing, in particular, and in other sectors where there is a desire for coatings featuring a good decorative effect and at the same time affording good protection against corrosion, it is known to provide substrates with two or more coating layers arranged atop one another.

Multicoat paint systems are applied preferably in accordance with what is called the basecoat/clearcoat process; that is, a pigmented basecoat material is applied first and, following a short flash-off time without a baking step (wet-on-wet process), is coated over with a clearcoat material. Subsequently, basecoat and clearcoat are baked together.

This method is widely employed, for example, for the OEM finishing of automobiles, and also for the painting of metal and plastic ancillary components. The current requirements imposed on the applications-technological and esthetic properties of such paint systems (coatings) are immense.

One problem which arises and yet has still not been satisfactorily solved by the prior art, is the incidence of what are called pinholes—i.e., the insufficient stability toward pinholes. On successive application of a number of coating materials—basecoat and clearcoat, for example—and in the absence of separate curing of each of the individual polymer layers, there may be unwanted inclusions of air, solvent and/or moisture, which may become perceptible in the form of bubbles beneath the surface of the overall paint system, and may break open in the course of the final curing. In this case, the amount of organic solvents and/or water present as a result of the overall construction of basecoat and clearcoat layers, and the quantity of air introduced by the application procedure, are too high to be able to escape from the multicoat paint system completely during the final curing step without the generation of defects. The holes that are formed in the paint system as a result, also called pinholes, lead to a disadvantageous visual appearance.

A further factor is that nowadays the replacement of coating materials based on organic solvents by aqueous coating materials is becoming ever more important in order to take into account the rising requirements for environmental friendliness.

Of advantage would therefore be a pigmented aqueous coating composition that exhibits a high stability towards pinholes, good optical and coloristic properties as well as excellent mechanical properties. It would also be advantageous for the composition to be suitable for the use in a “wet-on-wet” coating process. Moreover, the aqueous coating compositions should have a high storage stability.

Object

The object of the present invention, therefore, was that of providing a pigmented aqueous coating composition which can be used to produce coatings which no longer have the above-identified disadvantages of the prior art. More particularly, the use of the pigmented aqueous coating composition should result in an outstanding stability toward pinholes, especially if the coating composition is used in “wet-on-wet” processes. Additionally, the pigmented aqueous coating composition should have a high storage stability.

### Technical Solution

The objects described above are achieved by the subject matter claimed in the claims and also by the preferred embodiments of that subject matter that are described in the description hereinafter.

A first subject of the present invention is therefore a pigmented aqueous coating composition comprising
(a) at least one binder,
(b) at least one ester of glycerol with an unsaturated or saturated C₆-C₃₀ aliphatic monocarboxylic acid, preferably in a total amount of 0.01 to 1% by weight, based on the total weight of the coating composition, and
(c) at least one silica compound.

The above-specified aqueous coating composition is hereinafter also referred to as coating composition of the invention and accordingly is a subject of the present invention. Preferred embodiments of the coating composition of the invention are apparent from the description hereinafter and also from the dependent claims.

The coating composition of the invention has an excellent stability towards pinholes, especially if this coating composition is used in a “wet-on-wet” coating process. Without being bound to this theory, the excellent stability towards pinholes is believed to be resulting from the combination of, the ester compound (b) and the silica compound (c). Apart from the excellent stability towards pinholes, the inventive coating composition leads to coating layers having good optical and mechanical properties which are comparable to coating compositions not comprising the aforementioned combination of compounds (b) and (c).

A further subject of the present invention is a method for producing a multicoat paint system by producing a basecoat or two or more directly consecutive basecoats directly on a substrate optionally coated with a first coat, producing a clearcoat directly on the basecoat or the topmost of the two or more basecoats, and subsequently carrying out joint curing of the one or more basecoats and the clearcoat. At least one of the basecoat materials is the aqueous coating composition of the invention.

Yet a further subject of the present invention is a multicoat paint system which is obtainable by the method of the invention.

### DETAILED DESCRIPTION

### Definitions

First of all, a number of terms used in the context of the present invention will be explained.

The expression “aqueous coating composition” is known to the skilled person. It refers to a coating composition which is not based exclusively on organic solvents. “Aqueous” in the context of the present invention is therefore to be understood to mean that the coating composition comprises a water fraction of at least 20 wt. %, preferably at least 25 wt. %, very preferably at least 50 wt. %, based in each case on the total amount of the solvents present (that is, water and organic solvents). The water fraction in turn is preferably 30 to 70 wt. %, based on the total weight of the coating composition.

The term “binder” in the sense of the present invention and in agreement with DIN EN ISO 4618 (German version, date: March 2007), refers preferably to those nonvolatile fractions of the composition of the invention that are responsible for forming the film, with the exception of any pigments and fillers therein, and more particularly refers to the polymeric resins which are responsible for film formation.

The nonvolatile fraction may be determined by the method described in the Examples section.

The term “pigmented coating compositions” refers in accordance with the invention to coating compositions comprising at least one coloring and/or effect pigment.

The term “silica compound” refers in accordance with the invention to inorganic compounds of silicon dioxide. Said compounds can optionally be surface treated with inorganic or organic materials.

The term “(meth)acrylate” shall refer hereinafter both to acrylate and to methacrylate.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

The application of a coating composition to a substrate, or the production of a coating film on a substrate, are understood as follows: the respective coating composition is applied in such a way that the coating film produced therefrom is arranged on the substrate but need not necessarily be in direct contact with the substrate. Thus, other layers can be present between the coating film and the substrate. For example, in optional step (1), a cured coating layer (S1) is produced on the metallic substrate (S), but a conversion coating as described below, such as a zinc phosphate coating, may be arranged between the substrate and the cured coating layer (S1).

In contrast, the application of a coating composition directly to a substrate, or the production of a coating film directly on a substrate, results in a direct contact of the produced coating film and the substrate. Thus, more particularly, no other layer is present between the coating film and the substrate. Of course, the same principle applies to directly successive application of coating compositions or the production of directly successive coating films, for example in step (2)(b) of the present invention.

The term “flashing off” denotes the vaporization of organic solvents and/or water present in a coating composition after application, usually at ambient temperature (i.e. room temperature), for example 15 to 35° C. for a period of, for example, 0.5 to 30 minutes. Since the coating composition is still free-flowing at least directly after the application in droplet form, it can form a homogeneous, smooth coating film by running. After the flash-off operation, the coating film, however, is still not in a state ready for use. For example, it is no longer free-flowing, but is still soft and/or tacky, and in some cases only partly dried. More particularly, the coating film still has not cured as described below.

In contrast, intermediate drying takes place at, for example, higher temperatures and/or for a longer period, such that, in comparison to the flash-off, a higher proportion of organic solvents and/or water evaporates from the applied coating film. Thus, intermediate drying is usually performed at a temperature elevated relative to ambient temperature, for example of 40 to 90° C., for a period of, for example, 1 to 60 minutes. However, the intermediate drying does not give a coating film in a state ready for use either, i.e. a cured coating film as described below. A typical sequence of flash-off and intermediate drying operations would involve, for example, flashing off the applied coating film at ambient temperature for 5 minutes and then intermediately drying it at 80° C. for 10 minutes.

Accordingly, curing of a coating film is understood to mean the conversion of such a film to the ready-to-use state, i.e. to a state in which the substrate provided with the respective coating film can be transported, stored and used as intended. More particularly, a cured coating film is no longer soft or tacky, but has been conditioned as a solid coating film which does not undergo any further significant change in its properties, such as hardness or adhesion on the substrate, even under further exposure to curing conditions as described below.

The inventive coating composition can be formulated as one-component or two-component system. In one-component systems, the components to be crosslinked, for example organic polymers as binders and crosslinking agents, are present alongside one another, i.e. in one component. A prerequisite for this is that the components to be crosslinked react with one another, i.e. enter into curing reactions, only at relatively high temperatures of, for example, above 100° C. An example of a combination is that of hydroxy-functional polyesters and/or polyurethanes with melamine resins and/or blocked polyisocyanates as crosslinking agents. In two-component systems, the components to be crosslinked, for example the organic polymers as binders and the crosslinking agents, are present separately in at least two components which are combined only shortly prior to application. This form is chosen when the components to be crosslinked react with one another even at ambient temperatures or slightly elevated temperatures of, for example, 40 to 90° C.

An example of a combination is that of hydroxy-functional polyesters and/or polyurethanes and/or poly(meth)acrylates with free polyisocyanates as crosslinking agents.

The measurement methods to be employed in the context of the present invention for determining certain characteristic variables are evident from the Examples section.

Unless explicitly indicated otherwise, these measurement methods are to be used for determining the respective characteristic variable.

All the temperatures exemplified in the context of the present invention are understood as the temperature of the room in which the coated substrate is present.

What is thus not meant is that the substrate itself must have the particular temperature.

If reference is made in the context of the present invention to an official standard, this of course means the version of the standard that was current on the filing date, or, if no current version exists at that date, then the last current version.

Aqueous Coating Composition of the Invention:

Binder (a):

As a first essential constituent, the coating composition of the invention comprises at least one binder.

The binder is preferably present in a defined total amount in the aqueous coating composition of the invention. In one preferred embodiment of the present invention, therefore, the at least one binder is present in a total amount of 2 to 60 wt. % solids, preferably of 3 to 50 wt. % solids, more particularly of 5 to 45 wt. % solids, based in each case on the total binder content of the coating composition. If more than one binder is used, then the aforesaid quantity ranges are based on the total amount of binders in the composition. The use of the at least one binder in the aforesaid quantity ranges leads to good mechanical properties upon curing without adversely affecting the storage stability of the inventive compositions.

In the context of the present invention it has proven advantageous if the at least one binder is selected from the group consisting of polyurethanes, polyesters, poly(meth)acrylates, copolymers thereof and mixtures of these polymers. Especially preferred copolymers are copolymers of polyurethane and poly(meth)acrylate.

Preferably, the at least one binder is present in a total amount of 2 to 60 wt. % solids, preferably of 3 to 50 wt. % solids, more particularly of 5 to 45 wt. % solids, based in each case on the total solids content of the coating composition.

The polyurethane is preferably selected from anionically stabilized polyurethanes. Anionically stabilized binders in general and anionically stabilized polyurethanes in particular are understood in accordance with the invention to be binders which comprise groups that can be converted by neutralizing agents into anionic groups (potentially anionic groups). The anionic groups which can be converted by neutralizing agents into anionic groups are, for example, carboxylic, sulfonic and/or phosphonic acid groups, more particularly carboxylic acid groups.

The anionically stabilized polyurethane resins are used in the form of aqueous dispersions. The preparation of aqueous polyurethane resin dispersions is known to a person skilled in the art and is also described, for example, in EP-A-89,497. The anionically stabilized polyurethane resins used according to the invention are usually prepared by reacting:
(1) a polyester component comprising of the reaction product of
   a carboxylic acid component wherein said carboxylic acid component is comprised of at least 50% by weight, preferably 50 to 60% by weight, of at least one C₁₈-C₆₀-dicarboxylic acid, preferably a C₃₆ dicarboxylic acid, and at least one short-chain dicarboxylic acid, preferably phthalic anhydride; and
   an alcohol having at least two hydroxyl groups, preferably 1,6-hexanediol;
(2) a multi-functional compound having at least one active hydrogen and at least one carboxylic acid functionality, preferably 2,2-bis-(hydroxymethyl)-propionic acid;
(3) a polyisocyanate, preferably 3-isocyanatmethyl-3,5,5-trimethylcyclohexyl-isocyanat; and
(4) a compound having at least two active hydrogen groups selected from the group consisting of hydroxyl, sulfhydryl, primary and secondary amine, preferably trimethylol propane.

The polyurethane resins usually have a number average molecular Mₙ weight of at least 1,000 g/mol. The number average molecular weight Mₙ of the anionically stabilized polyurethane should preferably be at least 4,000 g/mol, particularly preferably between 5,000 and 8000 g/mol. The data on number average molecular weights cited in this application refer to measurements by gel permeation chromatography, performed with the aid of a polystyrene standard. A person skilled in the art is aware of a number of possibilities for influencing the molecular weight of the polyurethane resins. For example, the molecular weight can be influenced by the ratio between the equivalents of NCO groups used and the equivalents of groups reactive towards NCO groups used in the components (1), (2) and (4). Furthermore, the molecular weight can be regulated via the reaction of a prepolymer prepared from (1), (2) and (3) and containing NCO groups with the component (4) by the amount of the component (4) used. (4) functions as end group former or chain extender, depending on the ratio between the equivalents of free NCO groups and hydroxyl groups from the component (4). The molecular weight can also be regulated by terminating the reaction at the point in time at which the desired molecular weight has been reached, for example, by a rapid lowering of the reaction temperature and/or by the addition of a co-reactant which reacts with any isocyanate groups still present, without any chain extension taking place (for example water, the component (4) or a component comprising only one NCO-reactive group in a large excess).

It is preferred that the polyurethane resins have an acid value of 7 to 50 mg KOH/g solids, preferably 15 to 35 mg KOH/g solids, as determined according to DIN EN ISO 2114:2006-11.

The polyester polyols and polyether polyols usable as the component (1) are preferably polyester diols and polyether diols. Polyester diols are preferably used as the component (1). The component (1) is preferably employed in amounts which represent 50 to 80, particularly preferably 60 to 70 by weight % of the polyurethane resin, the percentages by weight referring to the solids content of the polyurethane resin dispersion.

Carboxyl groups are preferably introduced into the polyurethane resin molecules via the component (2). This can be effected, for example, with the aid of dihydroxypropionic acid, dihydroxysuccinic acid and dihydroxybenzoic acid. Preferred components (2) for introducing carboxyl groups into the polyurethane resin molecules are α,α-dimethylolalkanoic acids, such as 2,2-dimethylolacetic acid, 2,2-dimethylolpropionic acid, 2,2-dimethylolbutyric acid and 2,2-dimethylolpentanoic acid.

Carboxyl groups can also be introduced via the components (C) containing amino groups, such as α,ε-diaminovaleric acid and 3,4-diaminobenzoic acid. The use of the components (2) containing amino groups, however, is less preferred.

A diisocyanate of the formula (II) or a mixture of such diisocyanates is used as the component (3)

OCN—C(R¹R²)—X—C(R¹R²)—NCO (II)
wherein
X represents a divalent aromatic hydrocarbon radical, preferably a naphthylene, biphenylene, 1,2-phenylene, 1,3-phenylene or 1,4-phenylene radical, particularly preferably a 1,3-phenylene radical, each optionally substituted by halogen, methyl or methoxy, and
R¹ and R² represent, independently from each other, an alkyl radical having 1 to 4 carbon atoms, particularly preferably a methyl radical.

Other aliphatic and/or cycloalipatic and/or aromatic polyisocyanates can also be used in addition to the diisocyanates of the formula (II). Examples of additionally usable polyisocyanates are phenylene diisocyanate, tolylene diisocyanate, xylylene diisocyanate, bisphenylene diisocyanate, naphthylene diisocyanate, diphenylmethane diisocyanate, isophorone diisocyanate, cyclopentylene diisocyanate, cyclohexylene diisocyanate, methyl cyclohexylene diisocyanate, dicyclohexylmethane diisocyanate, trimethylene diisocyanate, tetramethylene diisocyanate, pentamethylene diisocyanate, hexamethylene diisocyanate, propylene diisocyanate, ethylethylene diisocyanate and trimethylhexane diisocyanate.

Polyisocyanates having functionalities higher than two can also be used in addition to diisocyanates. In this case, however, care must be taken that no crosslinked polyurethane resins are obtained. If desired, the average functionality can be lowered by using monoisocyanates at the same time.

It is preferred to use exclusively a diisocyanate of the formula (II) or a mixture of such diisocyanates as the component (3). It is particularly preferred to use 3-isocyanatmethyl-3,5,5-trimethylcyclohexyl-isocyanat as the component (3).

Compounds having a molecular weight of 60 to 400 g/mol (number average) which contain either at least two hydroxyl or amino groups, can be used in particular as the component (4). Aliphatic diol or triol compounds having 1 to 6 carbon atoms, such as methanol, ethanol, propanol, butanol, pentanol, hexanol or trimethylol propane are preferably used as the component (4).

The incorporation of the component (4) is preferably carried out in such a way that a prepolymer containing NCO groups is prepared first from (1), (2) and (3), which prepolymer is then further reacted in the aqueous phase with a component (4) (cf. EP-A-89,497). Afterwards, the carboxylic acid groups of component (2) are neutralized with a base. Both organic and inorganic bases can be used to neutralize the carboxylic acid groups. Primary, secondary and tertiary amines, such as ethylamine, propylamine, dimethylamine, dibutylamine, cyclohexylamine, benzylamine, morpholine, piperidine and triethanolamine, are used for preference.

Tertiary amines, especially dimethylethanolamine, triethylamine, tri propylamine and tributylamine, are used particularly preferably as the neutralizing agents.

The inventive coating compositions should in general contain the anionically stabilized polyurethane in a total amount of 2 to 15% by weight, preferably 3 to 12% by weight, more preferably 6 to 9% by weight, based in each case on the total weight of the coating composition.

Other water thinnable synthetic resins, such as amino resins, polyacrylate resins, polyester resins and polyether resins, can of course be used in addition to the aqueous anionically stabilized polyurethane resin dispersions under discussion.

Suitable resins are, for example, self-crosslinking aqueous dispersions comprising at least one polyhydrazide and at least one carbonyl-containing urethane-vinyl hybrid polymer. Suitable self-crosslinking aqueous dispersions are, for example, described in EP 0 649 865 A1.

Suitable polyester resins are reaction products of
a carboxylic acid component comprising 40 to 50% by weight of at least one C₁₈-C₆₀-dicarboxylic acid, preferably a C₃₆ dicarboxylic acid, and at least one short-chain dicarboxylic acid, preferably hexahydrophthalic anhydride and/or trimellitic anhydride; and
an alcohol component comprising at least one alcohol having at least two hydroxyl groups, preferably neopentyl glycol and/or 1,6-hexandiol and/or poly(tetramethylene oxide).

The polyesters preferably have an OH number of 20 to 110 mg KOH/g solids, preferably of 40 to 100 mg KOH/g solids, very preferably of 60 to 80 mg KOH/g solids, as determined according to DIN EN ISO 2114:2002-06.

The polyesters suitable within the present invention can be anionically stabilized or can be free of anionic groups. It is thus preferred, if polyester has an acid number of 0 to 80 mg KOH/g solids, preferably of 15 to 60 mg KOH/g solids, very preferably of 25 to 40 mg KOH/g solids, as determined according to DIN EN ISO 2114:2006-11.

The inventive coating compositions should in general contain the polyester in a total amount of 0.1 to 15% by weight, preferably 0.5 to 10% by weight, more preferably 1 to 5% by weight, based in each case on the total weight of the coating composition. The inventive coating compositions preferably also comprise at least one polyurethane poly(meth)acrylate, said polyurethane poly(meth)acrylate copolymer being obtained by radical polymerization of at least one unsaturated monomer in the presence of a polyurethane containing at least one unsaturated group. The polyurethane containing at least one unsaturated group is preferably obtained by reacting:
(1) a polyester component comprising of the reaction product of
   a carboxylic acid component wherein said carboxylic acid component is comprised of at least 50% by weight, preferably 50 to 60% by weight, of at least one C₁₈-C₆₀-dicarboxylic acid, preferably a C₃₆ dicarboxylic acid, and at least one short-chain dicarboxylic acid, preferably isophthalic acid; and
   an alcohol having at least two hydroxyl groups, preferably 1,6-hexanediol;
(2) a multi-functional compound having at least one active hydrogen and at least one carboxylic acid functionality, preferably 2,2-bis-(hydroxymethyl)-propionic acid;
(3) a polyisocyanate, preferably 3-isocyanatmethyl-3,5,5-trimethylcyclohexyl-isocyanat; and
(4) a reaction product of at least one cyclic amine, preferably N-methylpyrrolidone, at least one secondary amine comprising at least two hydroxy groups, preferably diethanolamine, and at least one aromatic monoisocyanate, preferably 1-(1-isocyanato-1-methylethyl)-3-(1-methylethenyl)-benzene.

The incorporation polyurethane is preferably prepared in such a way that a prepolymer containing NCO groups is prepared first from (1), (2) and (3), which prepolymer is then further reacted in the aqueous phase with the reaction product (4). Afterwards, the carboxylic acid groups of component (2) are neutralize with a base. Both organic and inorganic bases can be used to neutralize the carboxylic acid groups. Primary, secondary and tertiary amines, such as ethylamine, propylamine, dimethylamine, dibutylamine, cyclohexylamine, benzylamine, morpholine, piperidine and triethanolamine, are used for preference. Tertiary amines, especially dimethylethanolamine, triethylamine, tri propylamine and tributylamine, are used particularly preferably as the neutralizing agents.

Examples of monomers suitable for preparing the polyurethane poly(meth)acrylate copolymer used in the inventive composition are the following:

Monomers (a1)

Hydroxyalkyl esters of acrylic acid, methacrylic acid or another α,β-ethylenically unsaturated carboxylic acid which are derived from an alkylene glycol which is esterified with the acid, or are obtainable by reacting the acid with alkylene oxide, especially hydroxyalkyl esters of acrylic acid, methacrylic acid or ethacrylic acid in which the hydroxyalkyl group contains up to 20 carbon atoms, Such as 2-hydroxyethyl, 2-hydroxypropyl, 3-hydroxypropyl, 3-hydroxybutyl, 4-hydroxybutyl acrylate, methacrylate, ethacrylate or crotonate, 1,4-bis(hydroxymethyl) cyclohexane, octahydro-4,7-methano-1H-indenedimethanol or methylpropanediol monoacrylate, monomethacrylate, monoethacrylate or monocrotonate, or reaction products of cyclic esters, Such as ε-caprolactone, for example, and these hydroxyalkyl esters, or olefinically unsaturated alcohols, such as allyl alcohol or polyols, such as trimethylolpropane monoallyl or diallyl ether or pentaerythritol monoallyl, diallyl or triallyl ether. These monomers (a1) of higher functionality are generally used only in minor amounts of 2 to 10% by weight, based on the overall weight of the monomers used.

Monomers (a2)

(Meth)acrylic alkyl or cycloalkyl esters having up to 20 carbon atoms in the alkyl radical, especially methyl, ethyl, propyl, n-butyl, sec-butyl, tert-butyl, hexyl, ethylhexyl, Stearyl and lauryl acrylate or methacrylate, cycloaliphatic (meth)acrylic esters, especially cyclohexyl, isobornyl, dicyclopentadienyl, octahydro-4,7-methano-1H indenemethanol or tert-butylcyclohexyl (meth)acrylate; (meth)acrylic oxaalkyl esters or oxacycloalkyl esters such as ethyltriglycol (meth)acrylate and methoxy oligoglycol (meth)acrylate having a molecular weight Mₙ of preferably 550 g/mol; or other ethoxylated and/or propoxylated hydroxyl-free (meth)acrylic acid derivatives.

Monomers (a3)

Ethylenically unsaturated monomers which carry at least one acid group, preferably a carboxyl group, per molecule, or a mixture of such monomers. As component (a3) it is particularly preferred to use acrylic acid and/or methacrylic acid. It is also possible, however, to use other ethylenically unsaturated carboxylic acids having up to 6 carbon atoms in the molecule. Examples of such acids are ethacrylic acid, crotonic acid, maleic acid, fumaric acid, and itaconic acid. It is also possible to use ethylenically unsaturated sulfonic or phosphonic acids, and/or their partial esters, as component (a3). Further suitable monomers (a3) include mono(meth) acryloyl-oxyethyl maleate, succinate, and phthalate.

Monomers (a4)

Vinyl esters of alpha-branched monocarboxylic acids having 5 to 18 carbon atoms in the molecule. The branched monocarboxylic acids may be obtained by reacting formic acid or carbon monoxide and water with olefins in the presence of a liquid, Strongly acidic catalyst, the olefins may be cracking products from paraffinic hydrocarbons, such as mineral oil fractions, and may contain both branched and straight-chain acyclic and/or cycloaliphatic olefins. In the reaction of such olefins with formic acid and/or with carbon monoxide and water, a mixture of carboxylic acids is formed in which the carboxyl groups are located predominantly on a quaternary carbon atom. Other olefinic starting materials are, for example, propylene trimer, propylene tetramer, and disobutylene. Alternatively, the vinyl esters may be pre pared in a conventional manner from the acids, for example, by reacting the acid with acetylene. Particular preference owing to their ready availability is given to the use of vinyl esters of saturated aliphatic monocarboxylic acids having 9 to 11 carbon atoms and being branched on the alpha carbon atom.

Monomers (a5)

Reaction product of acrylic acid and/or methacrylic acid with the glycidyl ester of an alpha-branched monocarboxylic acid having 5 to 18 carbon atoms per molecule. The reaction of the acrylic or methacrylic acid with the glycidyl ester of a carboxylic acid having a tertiary alpha carbon atom may take place before, during or after the polymerization reaction. As component (a5) it is preferred to use the reaction product of acrylic and/or methacrylic acid with the glycidyl ester of Versatic® acid. This glycidyl ester is obtainable commercially under the name Cardura® E10.

Monomers (a6)

Ethylenically unsaturated monomers substantially free from acid groups, such as olefins, for example ethylene, propylene, 1-butene, 1-pentene, 1-hexene, cyclohexene, cyclopentene, norbornene, butadiene, isoprene, cyclopentadiene and/or dicyclopentadiene; (meth)acrylamides, such as (meth)acrylamide, N-methyl-, N,N-dimethyl-, N-ethyl-, N,N-diethyl-, N-propyl-, N,N-dipropyl, N-butyl-, N,N-dibutyl-, N-cyclohexyl and/or N,N-cyclohexyl-methyl-(meth)acrylamide; vinylaromatic hydrocarbons, such as styrene, alpha alkylstyrenes, especially α-methylstyrene, arylstyrenes, in particular diphenylethylene, and/or vinyltoluene, nitriles, such as acrylonitrile and/or methacrylonitrile; vinyl compounds such as vinyl chloride, vinyl fluoride, vinylidene dichloride, vinylidene difluoride; N-vinylpyrrollidone; vinyl ethers such as ethyl vinyl ether, n-propyl vinyl ether, isopropyl vinyl ether, n-butyl vinyl ether, isobutyl vinyl ether and/or vinyl cyclohexyl ether; vinyl esters, such as vinyl acetate, vinyl propionate, vinyl butyrate, vinyl pivalate, vinyl esters of Versatic® acids, and/or the vinyl ester of 2-methyl-2-ethylheptanoic acid; and/or polysiloxane macromonomers having on average from 0.5 to 2.5 ethylenically unsaturated double bonds per molecule, or acryloxysilane-containing vinyl monomers, obtainable by reacting hydroxy-functional silanes with epichlorohydrin and then reacting the reaction product with methacrylic acid and/or hydroxyalkyl esters of (meth)acrylic acid.

Particularly suitable unsaturated monomers are selected from the group consisting of hydroxyalkyl esters of (meth)acrylic acid, C₁-C₁₀ alkyl esters of (meth)acrylic acid, vinyl aromatic compounds and mixtures thereof.

The inventive coating compositions should in general contain the polyurethane poly(meth)acrylate copolymer in a total amount of 0.1 to 10% by weight, preferably 0.1 to 5% by weight, more preferably 0.5 to 2% by weight, based in each case on the total weight of the coating composition.

Particularly preferred coating compositions contain, as binder, at least the afore-described anionically stabilized polyurethane, polyester and polyurethane poly(meth)acrylate resins. In this respect, it is particularly preferred if the weight ratio of the anionically stabilized polyurethane to the polyester and the polyurethane poly(meth)acrylate copolymer is 15:8:1 bis 5:1:1, preferably 9:5:1 to 6:3:1.

Ester of Glycerol with Unsaturated or Saturated C₆-C₃₀ Aliphatic Monocarboxylic Acid (b):

As a second essential constituent (b), the coating composition of the invention comprises at least one ester of glycerol with unsaturated or saturated C₆-C₃₀ aliphatic monocarboxylic acid.

Compounds (b) in the sense of the present invention are glycerol compounds, which are partially or fully esterified with monocarboxylic acids—also called mono-, di- or triglycerides. Compound (b) thus comprises a glycerol backbone which is esterified with one, two or three saturated or unsaturated acid components, each acid component comprising 6 to 30 carbon atoms. The compound (b) preferably has a number-average molecular weight of from about 400 to about 1,000 g/mol. The acid component is preferably selected from at least one of linseed oil, soybean oil, sunflower seed oil, safflower oil, hempseed oil, tung oil, oiticica oil, corn oil, sesame oil, cottonseed oil, castor oil, olive oil, peanut oil, rapeseed oil, coconut oil, babassu oil, and palm oil. It is to be appreciated that various combination and mixtures of the above acid components may also be utilized with the subject invention.

It is particularly preferred, if the acid component is selected from palmitic acid, stearic acid, linoleic acid and oleic acid and mixtures thereof. An especially suitable compound (b) is a mixture of mono-, di and triglycerides of the aforestated acid component, i.e. mono-, di- and triglycerides of palmitic acid, stearic acid, linoleic acid and oleic acid. Use of said mixture of mono-, di- and triglycerols in combination with compound (c) leads to a significant reduction of pinholes in coating layers prepared with the inventive coating composition.

The at least one compound (b), especially a mixture of mono-, di- and triglycerols of palmitic acid, stearic acid, linoleic acid and oleic acid, is preferably present in a total amount of 0.01 to 1% by weight, more preferably 0.05 to 0.5% by weight, very preferably 0.15 to 0.4% by weight, based in each case on the total weight of the coating composition.

Silica Compound (c):

As a third essential constituent (c), the coating composition of the invention comprises at least one silica compound.

Particular preferred silica compounds (c) are selected from fumed silica. Fumed silica (CAS number 112945-52-5), also known as pyrogenic silica because it is produced in a flame, consists of microscopic droplets of amorphous silica fused into branched, chainlike, three-dimensional secondary particles which then agglomerate into tertiary particles. The resulting powder has an extremely low bulk density and high surface area.

The at least one silica compound (d), preferably fumed silica, is present in a total amount of 0.001 to 1% by weight, preferably 0.005 to 0.5% by weight, more preferably 0.01 to 0.1% by weight, based in each case on the total weight of the coating composition. Use of the stated amounts of the silica compound (d), preferably fumed silica, in combination with compound (b) and (c) leads to reduced pinholes in coating layers prepared from the inventive coating composition.

Pigments:

The inventive coating compositions are pigmented compositions, i.e. they comprise at least one coloring and/or effect pigment. Such color pigments are known to those skilled in the art and are described, for example, in Römpp-Lexikon Lacke and Druckfarben, Georg Thieme Verlag, Stuttgart, New York, 1998, pages 176 and 451. The terms “coloring pigment” and “color pigment” are interchangeable.

Suitable color pigments are preferably selected from the group consisting of (i) white pigments such as titanium dioxide, zinc white, zinc sulfide or lithopone; (ii) black pigments such as carbon black, iron manganese black, or spinel black; (iii) chromatic pigments such as ultramarine green, ultramarine blue, manganese blue, ultramarine violet, manganese violet, red iron oxide, molybdate red, ultramarine red, brown iron oxide, mixed brown, spinel phases and corundum phases, yellow iron oxide, bismuth vanadate; (iv) organic pigments such as monoazo pigments, bisazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, prinone pigments, perylene pigments, phthalocyanine pigments, aniline black; and (v) mixtures thereof.

Suitable effect pigments are preferably selected from the group consisting of (i) platelet-shaped metal effect pigments such as lamellar aluminum pigments, (ii) gold bronzes; (iii) oxidized bronzes and/or iron oxide-aluminum pigments; (iv) pearlescent pigments such as pearl essence; (v) basic lead carbonate; (vi) bismuth oxide chloride and/or metal oxide-mica pigments; (vii) lamellar pigments such as lamellar graphite, lamellar iron oxide; (viii) multilayer effect pigments composed of PVD films; (ix) liquid crystal polymer pigments; and (x) mixtures thereof.

The at least one pigment, preferably at least one coloring and/or effect pigment, is favorably present in a total amount of 1 to 40% by weight, preferably of 2 to 35% by weight, more preferably of 5 to 30% by weight, based in each case on the total weight of the coating composition.

Compound of general formula (I):

The coating composition of the invention can further comprise at least one hydroxy compound of general formula (I).

Preferred compounds of general formula (I) comprise linear alkyl groups as residue R₁. It is thus favorable if residue R₁ in general formula (I) is a linear or branched C₂-C₈ alkyl group, preferably a linear or branched C₂-C₆ alkyl group, very preferably a linear C₃ or C₄ alkyl group.

Compounds of formula (I) preferably used in the inventive coating composition are either branched or linear hydroxy compounds. Therefore, residue R₂ in general formula (I) is preferably hydrogen or a linear C₁-C₄ alkyl group, more preferably hydrogen or a C₁ alkyl group, very preferably hydrogen or a C₁ alkyl group.

Integers a and b in formula (I) preferably denote specific integral numbers. It is thus favorable, if a in general formula (I) is an integral number of 0 or 1, preferably 0.

Preferably, b in general formula (I) is an integral number of 1 to 8, preferably 1 to 6, more preferably 1 to 4, very preferably 1.

Particularly preferred compounds of general formula (I) are selected from n-propoxypropanol or n-butoxypropanol.

In order to avoid a negative influence on the reduction of the number of pinholes achieved by the use of above-described components (b) and (c), the inventive coating composition preferably contains the compound of general formula (I) in specific amounts. It is therefore preferred, if the compound of general formula (I) is present in a total amount of 0.1 to 15% by weight, preferably 0.5 to 10% by weight, more preferably 1 to 5% by weight, based in each case on the total weight of the coating composition.

Further Constituents:

The pigmented aqueous coating composition of the invention may, besides the above-recited mandatory constituents (a) to (c) and the compound of formula (I), also comprise further constituents, selected from the group of polypropylene oxide, neutralizing agents, thickeners, crosslinking agents, additives and mixtures thereof.

The polypropylene oxide preferably has an average molecular weight M_{w} of 200 to 4,000 g/mol, more preferably 1,000 to 3,500 g/mol, very preferably 2,000 to 3,000 g/mol, as determined according to gel permeation chromatography using polystyrene as internal standard.

It is preferred in this context if the polypropylene oxide is present in a total amount of 0.01 to 1% by weight, more preferably 0.05 to 0.5% by weight, very preferably 0.15 to 0.4% by weight, based in each case on the total weight of the coating composition.

Suitable neutralizing agents, thickeners and crosslinking agents are well known to the person skilled in the art and can be present in customary amounts.

In addition, the inventive composition can also comprise at least one additive. Examples of such additives are salts which can be broken down thermally without residue or substantially without residue, resins that are different from the polymers already mentioned, organic solvents, reactive diluents, transparent pigments, fillers, dyes soluble in a molecular dispersion, nanoparticles, light stabilizers, antioxidants, deaerating agents, emulsifiers, slip additives, polymerization inhibitors, initiators of free-radical polymerizations, adhesion promoters, flow control agents, film-forming assistants, sag control agents (SCAs), flame retardants, corrosion inhibitors, waxes, siccatives, biocides, and flatting agents. Suitable additives of the aforementioned kind are known, for example, from German patent application DE 199 48 004 A1, page 14 line 4 to page 17 line 5, German patent DE 100 43 405 C1, column 5, paragraphs [0031] to [0033]. They are used in the customary and known amounts. For example, the proportion thereof may be in the range from 1.0 to 20% by weight, based in each case on the total weight of the coating composition.

The coating composition of the invention has a relatively high solids. The solids content is guided primarily by the viscosity required for application, more particularly for spray application, and so may be adjusted by the skilled person on the basis of his or her general art knowledge, optionally with assistance from a few exploratory tests. It is therefore preferred if the composition has a solids content of 10 to 60 wt. %, more preferably 12 to 55 wt. %, very preferably 15 to 50 wt. %, based in each case on the total weight of the coating composition and measured according to DIN EN ISO 3251 (June 2008). In light of the high solids content, the coating compositions of the invention have a good environmental profile without any adverse effect, though, on their storage stability. The storage stability can be described for example by viscosity measurements in the liquid state over time.

Inventive Method for Producing a Multicoat Paint System:

The inventive method for producing a multicoat paint system (M) on a substrate (S), comprises the following steps:
(1) optionally producing a cured first coating layer (S1) on the substrate (S) by application of a composition (Z1) to the substrate (S) and subsequent curing of the applied composition (Z1),
(2) producing a basecoat layer (BL2a) or at least two directly consecutive basecoat layers (BL2-x) directly on the first coating layer (S1) by application of an aqueous basecoat material (bL2a) directly to the first coating layer (S1) or directly consecutive application of at least two aqueous basecoat materials (bL2-x) directly to the first coating layer (S1),
(3) producing a clearcoat layer (C) directly on the basecoat layer (BL2a) or on the topmost basecoat layer (BL2-z) by application of a clearcoat material (cm) directly to the basecoat layer (BL2a) or to the topmost basecoat layer (BL2-z),
(4) jointly curing the basecoat layer (BL2a) and the clearcoat layer (C) or the basecoat layers (BL2-x) and the clearcoat layer (C),
wherein
the at least one basecoat material (bL2a) or at least one of the basecoat materials (bL2-x) comprises an inventive coating composition.

The substrate (S) is preferably selected from metallic substrates, plastic substrates, reinforced plastic substrates and substrates comprising metallic and plastic components, especially preferably from metallic substrates.

In this respect, preferred metallic substrates (S) are selected from iron, aluminum, copper, zinc, magnesium and alloys thereof as well as steel. Preferred substrates are those of iron and steel, examples being typical iron and steel substrates as used in the automobile industry sector. The substrates themselves may be of whatever shape—that is, they may be, for example, simple metal panels or else complex components such as, in particular, automobile bodies and parts thereof.

Preferred plastic substrates (S) are basically substrates comprising or consisting of (i) polar plastics, such as polycarbonate, polyamide, polystyrene, styrene copolymers, polyesters, polyphenylene oxides and blends of these plastics, (ii) synthetic resins such as polyurethane RIM, SMC, BMC and (iii) polyolefin substrates of the polyethylene and polypropylene type with a high rubber content, such as PP-EPDM, and surface-activated polyolefin substrates. The plastics may furthermore be fiber-reinforced, in particular using carbon fibers and/or metal fibers.

As substrates (S) it is also possible, moreover, to use those which contain both metallic and plastics fractions. Substrates of this kind are, for example, vehicle bodies containing plastics parts.

The substrates (S) may be pretreated before step (1) of the inventive process or before applying the composition (Z1) in any conventional way—that is, for example, cleaned (for example mechanically and/or chemically) and/or provided with known conversion coatings (for example by phosphating and/or chromating) or surface activating pre-treatments (for example by flame treatment, plasma treatment and corona discharge coming).

Step (1):

In step (1) of the inventive process, a cured first coating layer (S1) may be produced on the substrate (S) by application of a composition (Z1) to the substrate (S) and subsequent curing of the composition (Z1). This step is preferably performed if the substrate (S) is a metallic substrate.

The composition (Z1) may be an electrocoat material and may also be a primer coat. A primer coat in accordance with the invention, however, is not the basecoat applied in step (2) of the method of the invention. The method of the invention is preferably carried out with metallic substrates (S). The first coat (S1), therefore, is more particularly a cured electrocoat (E1). In one preferred embodiment of the method of the invention, accordingly, the composition (Z1) is an electrocoat material which is applied electrophoretically to the substrate (S). Suitable electrocoat materials and also their curing are described in WO 2017/088988 A1, WO 9833835 A1, WO 9316139 A1, WO 0102498 A1 and WO 2004018580 A1.

The composition (Z1) applied is flashed off, for example, at 15 to 35° C. for a period of, for example, 0.5 to 30 minutes and/or intermediately dried at a temperature of preferably 40 to 90° C. for a period of, for example, 1 to 60 minutes. The composition (Z1) applied to the substrate (or the as yet uncured composition applied) is preferably cured at temperatures of 100 to 250° C., preferably 140 to 220° C. for a period of 5 to 60 minutes, preferably 10 to 45 minutes, which produces the cured first coating layer (S1).

The layer thickness of the first coating layer (S1) is, for example, to 40 μm, preferably 15 to 25 μm.

Step (2):

Step (2) of the inventive process either comprises production of exactly one basecoat layer (BL2a) (step (2)(a)) or production of at least two directly successive basecoat layers (BL2-a) and (BL2-z) (step (2)(b)). The layers are produced by (a) applying an aqueous basecoat composition (BL2a) directly to the substrate (S) or the cured first coating layer (S1) or (b) directly successively applying at least two basecoat compositions (BL2-a) and (BL2-z) to the substrate (S) or the cured first coating layer (S1). After having been produced, therefore, the basecoat film (BL2a) according to step (2)(a) is disposed directly on the substrate (S) or directly on the cured first coating layer (S1).

The directly successive application of at least two, i.e. a plurality of, basecoat compositions to the to the substrate (S) or the cured first coating layer (S1) is thus understood to mean that a first basecoat composition (BL2-a) is applied directly to the substrate (S) or the cured first coating layer (S1) and then a second basecoat composition (BL2-b) is applied directly to the layer of the first basecoat composition. Any third basecoat composition (BL2-c) is then applied directly to the layer of the second basecoat composition. This operation can then be repeated analogously for further basecoat compositions (i.e. a fourth, fifth, etc. basecoat composition). The uppermost basecoat layer obtained after step (2)(b) of the inventive method is denoted as basecoat layer (BL2-z).

The basecoat layer (BL2a) or the first basecoat layer (BL2-a) is thus arranged directly on the substrate (S) or the cured first coating layer (S1).

The terms “basecoat composition” and “basecoat layer” in relation to the coating compositions applied and coating films produced in step (2) of the inventive process are used for the sake of better clarity. The basecoat layer or layers is/are cured together with the clearcoat material, the curing is thus achieved analogously to the curing of so-called basecoat compositions used in the standard method described in the introduction. More particularly, the coating compositions used in step (2) of the process of the invention are not cured separately, like the coating compositions referred to as primer-surfacers in the context of the standard methods. In connection with step (2)(b), the basecoat compositions and basecoat layers are generally designated by (bL2-x) and (BL2-x), wherein the x is be replaced by other appropriate letters in the naming of the specific individual basecoat compositions and basecoat layers.

A preferred embodiment of the inventive method is the preparation of one basecoat layer (BL2a) according to step (2)(a) of the inventive method by using the inventive coating composition.

If step (2)(b) of the inventive method is performed, the basecoat composition (bL2-z) contains at least one binder. A preferred aqueous basecoat compositions (bL2-z) therefore comprises at least one hydroxy-functional polymer as binder, said at least one hydroxy-functional polymer being selected from the group consisting of a polyurethane, a polyester, a polyacrylate, copolymers thereof and mixtures of these polymers. Preferred polyurethane-polyacrylate copolymers (acrylated polyurethanes) and the preparation thereof are described, for example, in WO 91/15528 A1, page 3 line 21 to page 20 line 33, and in DE 4437535 A1, page 2 line 27 to page line 22. The binders preferably possess an OH number in the range from 20 to 200 mg KOH/g, more preferably from 40 to 150 mg KOH/g.

The proportion of the binder, preferably the at least one polyurethane-polyacrylate copolymer, is preferably in the range from 0.5 to 20% by weight, more preferably 1 to 15% by weight, especially preferably 1.5 to 10% by weight, based in each case on the total weight of the aqueous basecoat composition.

The basecoat composition (bL2-z) used in step (2)(b) of the inventive process is favorably colored, i.e. it preferably contain at least one coloring and/or effect pigment. Thus, the aqueous basecoat composition (bL2-z) preferably comprises at least one coloring and/or effect pigment, more preferably at least one coloring and effect pigment.

In this regard, preferred pigments are pigments described in connection with the inventive coating composition.

In addition, the basecoat composition (bL2-z) used in step (2)(b) of the inventive process preferably comprises at least one typical crosslinking agent known per se. Favorably, the aqueous basecoat (bL2-z) comprises at least one crosslinking agent selected from the group consisting of blocked polyisocyanates and/or aminoplast resins, preferably aminoplast resins. Among the aminoplast resins, melamine resins in particular are preferred.

The proportion of the crosslinking agents, especially aminoplast resins and/or blocked polyisocyanates, more preferably aminoplast resins, among these preferably melamine resins, is preferably in the range from 0.5 to 20% by weight, more preferably 1 to 15% by weight, especially preferably 1.5 to 10% by weight, based in each case on the total weight of the aqueous basecoat composition (bL2-z).

Preferably, the basecoat composition (bL2-z) used in step (2)(b) of the inventive process additionally comprises at least one thickener. Suitable thickeners are known to the person skilled in the art. An especially preferred thickener is selected from the group of phyllosilicates. The proportion of the thickeners is preferably in the range from 0.01 to 5% by weight, preferably 0.02 to 4% by weight, more preferably 0.05 to 3% by weight, based in each case on the total weight of the aqueous basecoat composition (bL2-z).

In addition, the aqueous basecoat composition (bL2-z) may also comprise at least one additive. Suitable additives are described in connection with the inventive coating composition. They are used in the customary and known amounts. For example, the proportion thereof may be in the range from 1.0 to 20% by weight, based in each case on the total weight of the aqueous basecoat composition (bL2-z).

The solids content of the basecoat composition (bL2-z) is preferably 5 to 70% by weight, more preferably 8 to 60% by weight, most preferably 12 to 55% by weight. The solid content can be determined as described in the examples.

The basecoat composition (bL2-x) is aqueous. “Aqueous” for the purposes of the present invention should preferably be understood to mean that the basecoat composition has a water fraction of at least 40% by weight, preferably at least 45% by weight, very preferably at least 50% by weight, based in each case on the total amount of the solvents present (i.e., water and organic solvents). Preferably in turn, the water fraction is 40 to 95% by weight, more particularly 45 to 90% by weight, very preferably 50 to 85% by weight, based in each case on the total amount of solvents present.

The basecoat compositions used in accordance with the invention can be produced using the mixing assemblies and mixing techniques that are customary and known for the production of basecoat materials.

The basecoat films (BL2a) and (BL2-x) are cured together with the clearcoat material. In particular, the coating compositions as used in step (2) of the method of the invention are not cured separately. The basecoat films (BL2a) and (BL2-x) are therefore preferably not exposed to temperatures of above 100° C. for a time of longer than 1 minute, and with particular preference are not exposed at all to temperatures of more than 100° C.

The basecoat materials (bL2a) and (bL2-x) are applied such that, after the curing in step (4), the basecoat film (BL2a) and the individual basecoat films (BL2-x) each have a film thickness of, for example, 5 to 50 micrometers, preferably 6 to 40 micrometers, especially preferably 7 to 35 micrometers. In the first alternative of step (2), preference is given to producing basecoat films (BL2a) having relatively high film thicknesses of 15 to 50 micrometers, preferably 20 to 45 micrometers. In the second alternative of step (2), the individual basecoat films (BL2-x) tend to have film thicknesses which are lower by comparison, with the overall system then again having film thicknesses which lie within the order of magnitude of the one basecoat film (BL2a). In the case of two basecoat films, for example, the first basecoat film (BL2-a) preferably has film thicknesses of 5 to 35 micrometers, more particularly 10 to 30 micrometers, the second basecoat film (BL2-z) preferably has film thicknesses of 5 to 35 micrometers, more particularly 10 to 30 micrometers, and the overall film thickness does not exceed 50 micrometers.

Step (3):

In step (3) of the method of the invention, a clearcoat film (K) is produced directly on the basecoat film (BL2a) or on the topmost basecoat film (BL2-z). This production is accomplished by corresponding application of a clearcoat material (k). Suitable clearcoat materials are described for example in WO 2006042585 A1, WO 2009077182 A1 or else WO 2008074490 A1.

The clearcoat material (k) or the corresponding clearcoat film (K), following application, is flashed and/or interim-dried preferably at 15 to 35° C. for a time of 0.5 to 30 minutes.

The clearcoat material (k) is applied in such a way that the film thickness of the clearcoat film after the curing in step (4) is from, for example, 15 to 80 micrometers, preferably 20 to 65 micrometers, especially preferably 25 to 60 micrometers.

Step (4):

In step (4) of the method of the invention, there is joint curing of the basecoat film (BL2a) and of the clearcoat film (K), or of the basecoat films (BL2-x) and of the clearcoat film (K).

The joint curing takes place preferably at temperatures of 60 to 250° C., preferably 70 to 180° C., very preferably 80 to 160° C., for a duration of 5 to 60 minutes.

The method of the invention allows the production of multicoat paint systems on substrates without a separate curing step. Nevertheless, the multicoat paint systems resulting from application of the method of the invention have good optical and coloristic properties, especially a reduced amount of pinholes.

In respect of further preferred embodiments of the method of the invention, especially in respect of the basecoat compositions used therein and of the components of these basecoat compositions, the statements made in relation to the coating composition of the invention are valid mutatis mutandis.

Multicoat Paint System of the Invention:

After the end of step (4) of the method of the invention, the result is a multicoat paint system (M) of the invention.

In respect of further preferred embodiments of the multicoat paint system of the invention, the comments made regarding the coating composition of the invention and also regarding the method of the invention are valid mutatis mutandis.

The invention is described in particular by the following embodiments:

According to a first embodiment, the present invention relates to a pigmented aqueous coating composition comprising
(a) at least one binder,
(b) at least one ester of glycerol with an unsaturated or saturated C₆-C₃₀ aliphatic monocarboxylic acid, preferably in a total amount of 0.01 to 1% by weight, based on the total weight of the coating composition, and
(c) at least one silica compound.

According to a second embodiment, the present invention relates to a composition according to embodiment 1, wherein the at least one binder is present in a total amount of 2 to 60 wt. % solids, preferably of 3 to 50 wt. % solids, more particularly of 5 to 45 wt. % solids, based in each case on the total binder content of the coating composition.

According to a third embodiment, the present invention relates to a composition according to embodiment 1 or 2, wherein the at least one binder is selected from the group consisting of polyurethanes, polyesters, poly(meth)acrylates, copolymers thereof and mixtures of these polymers.

According to a fourth embodiment, the present invention relates to a composition according to embodiment 3, wherein the polyurethane is an anionically stabilized polyurethane.

According to a fifth embodiment, the present invention relates to a composition according embodiment 3 or 4, wherein the anionically stabilized polyurethane is obtained by reacting:
(1) a polyester component comprising of the reaction product of
   a carboxylic acid component wherein said carboxylic acid component is comprised of at least 50% by weight, preferably 50 to 60% by weight, of at least one C₁₈-C₆₀-dicarboxylic acid, preferably a C₃₆ dicarboxylic acid, and at least one short-chain dicarboxylic acid, preferably phthalic anhydride; and
   an alcohol having at least two hydroxyl groups, preferably 1,6-hexanediol;
(2) a multi-functional compound having at least one active hydrogen and at least one carboxylic acid functionality, preferably 2,2-bis-(hydroxymethyl)-propionic acid;
(3) a polyisocyanate, preferably 3-isocyanatmethyl-3,5,5-trimethylcyclohexyl-isocyanat; and
(4) a compound having at least two active hydrogen groups selected from the group consisting of hydroxyl, sulfhydryl, primary and secondary amine, preferably trimethylol propane.

According to a sixth embodiment, the present invention relates to a composition according to any embodiment 3 to 5, wherein the anionically stabilized polyurethane has a number average molecular weight Mₙ of at least 1,000 g/mol, preferably at least 3,000 g/mol, more preferably 5,000 to 8,000 g/mol, determined by gel permeation chromatography using polystyrene as internal standard.

According to a seventh embodiment, the present invention relates to a composition according to any of embodiments 3 to 6, wherein the anionically stabilized polyurethane is present in a total amount of 2 to 15% by weight, preferably 3 to 12% by weight, more preferably 6 to 9% by weight, based in each case on the total weight of the coating composition.

According to an eighth embodiment, the present invention relates to a composition according to any of embodiments 3 to 7, wherein the polyester is a reaction product of
a carboxylic acid component comprising 40 to 50% by weight of at least one C₁₈-C₆₀-dicarboxylic acid, preferably a C₃₆ dicarboxylic acid, and at least one short-chain dicarboxylic acid, preferably hexahydrophthalic anhydride and/or trimellitic anhydride; and
an alcohol component comprising at least one alcohol having at least two hydroxyl groups, preferably neopentyl glycol and/or 1,6-hexandiol and/or poly(tetramethylene oxide).

According to a ninth embodiment, the present invention relates to a composition according to any of embodiments 3 or 8, wherein the polyester has a OH number of to 110 mg KOH/g solids, preferably of 40 to 100 mg KOH/g solids, very preferably of 60 to 80 mg KOH/g solids, as determined according to DIN EN ISO 2114:2002-06.

According to a tenth embodiment, the present invention relates to a composition according to any of embodiments 3 to 9, wherein the polyester has an acid number of 0 to 80 mg KOH/g solids, preferably of 15 to 60 mg KOH/g solids, very preferably of to 40 mg KOH/g solids, as determined according to DIN EN ISO 2114:2006-11.

According to an eleventh embodiment, the present invention relates to a composition according to any of embodiments 3 to 10, wherein the polyester is present in a total amount of 0.1 to 15% by weight, preferably 0.5 to 10% by weight, more preferably 1 to 5% by weight, based in each case on the total weight of the coating composition.

According to a twelfth embodiment, the present invention relates to a composition according to any of embodiments 3 to 11, wherein the polyurethane poly(meth)acrylate copolymer is obtained by radical polymerization of at least one unsaturated monomer in the presence of a polyurethane containing at least one unsaturated group.

According to a thirteenth embodiment, the present invention relates to a composition according to embodiment 12, wherein the polyurethane containing at least one unsaturated group is obtained by reacting:
(1) a polyester component comprising of the reaction product of
   a carboxylic acid component wherein said carboxylic acid component is comprised of at least 50% by weight, preferably 50 to 60% by weight, of at least one C₁₈-C₆₀-dicarboxylic acid, preferably a C₃₆ dicarboxylic acid, and at least one short-chain dicarboxylic acid, preferably isophthalic acid; and
   an alcohol having at least two hydroxyl groups, preferably 1,6-hexanediol;
(2) a multi-functional compound having at least one active hydrogen and at least one carboxylic acid functionality, preferably 2,2-bis-(hydroxymethyl)-propionic acid;
(3) a polyisocyanate, preferably 3-isocyanatmethyl-3,5,5-trimethylcyclohexyl-isocyanat; and
(4) a reaction product of at least one cyclic amine, preferably N-methylpyrrolidone, at least one secondary amine comprising at least two hydroxy groups, preferably diethanolamine, and at least one aromatic monoisocyanate, preferably 1-(1-isocyanato-1-methylethyl)-3-(1-methylethenyl)-benzene.

According to a fourteenth embodiment, the present invention relates to a composition according to embodiment 12 or 13, wherein the at least one unsaturated monomer is selected from the group consisting of hydroxyalkyl esters of (meth)acrylic acid, C₁-C₁₀alkyl esters of (meth)acrylic acid, vinyl aromatic compounds and mixtures thereof.

According to a fifteenth embodiment, the present invention relates to a composition according to any of embodiments 3 to 14, wherein the polyurethane poly(meth)acrylate copolymer is present in a total amount of 0.1 to 10% by weight, preferably 0.1 to 5% by weight, more preferably 0.5 to 2% by weight, based in each case on the total weight of the coating composition.

According to a sixteenth embodiment, the present invention relates to a composition according to any of embodiments 3 to 15, wherein the weight ratio of the anionically stabilized polyurethane to the polyester and the polyurethane poly(meth)acrylate copolymer is 15:8:1 bis 5:1:1, preferably 9:5:1 to 6:3:1.

According to a seventeenth embodiment, the present invention relates to a composition according to any of the proceeding embodiments, wherein the acid component of the triacyl glycerol is selected from palmitic acid, stearic acid, linoleic acid and oleic acid and mixtures thereof.

According to a eighteenth embodiment, the present invention relates to a composition according to any of the proceeding embodiments, wherein the at least one ester of glycerol with an unsaturated or saturated C₆-C₃₀ aliphatic monocarboxylic acid is present in a total amount of 0.01 to 1% by weight, preferably 0.05 to 0.5% by weight, very preferably 0.15 to 0.4%, based in each case on the total weight of the coating composition According to a nineteenth embodiment, the present invention relates to a composition according to any of the proceeding embodiments, wherein the at least one silica compound is selected from fumed silica.

According to a twentieth embodiment, the present invention relates to a composition according to any of the proceeding embodiments, wherein the at least one silica compound, preferably fumed silica, is present in a total amount of 0.001 to 1% by weight, preferably 0.005 to 0.5% by weight, more preferably 0.01 to 0.1% by weight, based in each case on the total weight of the coating composition.

According to a twenty-first embodiment, the present invention relates to a composition according to any of the proceeding embodiments, wherein the pigment is selected from coloring and/or effect pigments.

According to a twenty-second embodiment, the present invention relates to a composition according to embodiment 21, wherein the coloring pigment is selected from the group consisting of (i) white pigments such as titanium dioxide, zinc white, zinc sulfide or lithopone; (ii) black pigments such as carbon black, iron manganese black, or spinel black; (iii) chromatic pigments such as ultramarine green, ultramarine blue, manganese blue, ultramarine violet, manganese violet, red iron oxide, molybdate red, ultramarine red, brown iron oxide, mixed brown, spinel phases and corundum phases, yellow iron oxide, bismuth vanadate; (iv) organic pigments such as monoazo pigments, bisazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, prinone pigments, perylene pigments, phthalocyanine pigments, aniline black; and (v) mixtures thereof.

According to a twenty-third embodiment, the present invention relates to a composition according to embodiment 21 or 22, wherein the effect pigment is selected from the group consisting of (i) platelet-shaped metal effect pigments such as lamellar aluminum pigments, (ii) gold bronzes; (iii) oxidized bronzes and/or iron oxide-aluminum pigments; (iv) pearlescent pigments such as pearl essence; (v) basic lead carbonate; (vi) bismuth oxide chloride and/or metal oxide-mica pigments; (vii) lamellar pigments such as lamellar graphite, lamellar iron oxide; (viii) multilayer effect pigments composed of PVD films; (ix) liquid crystal polymer pigments; and (x) mixtures thereof.

According to a twenty-fourth embodiment, the present invention relates to a composition according to any of embodiments 21 to 23, wherein the at least one pigment, preferably at least one coloring and/or effect pigment, is present in a total amount 1 to 40% by weight, preferably 2 to 35% by weight, more preferably 5 to 30% by weight, based in each case on the total weight of the coating composition.

According to a twenty-fifth embodiment, the present invention relates to a composition according to any of the preceding embodiments, wherein the composition further comprises at least one compound of general formula (I)

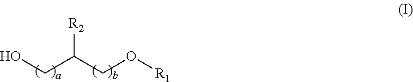

wherein
R₁, is a linear or branched C₁-C₁₀ alkyl group,
R₂ is hydrogen or a linear or branched C₁-C₁₀ alkyl group,
   a is an integral number of 0 to 10 and
   b is an integral number of 1 to 10

According to a twenty-sixth embodiment, the present invention relates to a composition according to embodiment 25, wherein the residue R₁ in general formula (I) is a linear or branched C₂-C₈ alkyl group, preferably a linear or branched C₂-C₆ alkyl group, very preferably a linear C₃ or C₄ alkyl group.

According to an twenty-seventh embodiment, the present invention relates to a composition according to embodiment 25 or 26, wherein the residue R₂ in general formula (I) is hydrogen or a linear C₁-C₄ alkyl group, preferably hydrogen or a C₁ alkyl group, very preferably hydrogen or a C₁ alkyl group.

According to a twenty-eighth embodiment, the present invention relates to a composition according to any of embodiments 25 to 27, wherein a in general formula (I) is an integral number of 0 or 1, preferably 0.

According to a twenty-ninth embodiment, the present invention relates to a composition according to any of embodiments 25 to 28, wherein b in general formula (I) is an integral number of 1 to 8, preferably 1 to 6, more preferably 1 to 4, very preferably 1.

According to a thirtieth embodiment, the present invention relates to a composition according to any of embodiments 25 to 29, wherein the compound of general formula (I) is selected from n-propoxypropanol or n-butoxypropanol.

According to a thirty-first embodiment, the present invention relates to a composition according to any of embodiments 25 to 30, wherein the compound of general formula (I) is present in a total amount of 0.1 to 15% by weight, preferably 0.5 to 10% by weight, more preferably 1 to 5% by weight, based in each case on the total weight of the coating composition.

According to a thirty-second embodiment, the present invention relates to a composition according to any of the proceeding embodiments, wherein the composition further comprises polypropylene oxide.

According to a thirty-third embodiment, the present invention relates to a composition according to embodiment 32, wherein the polypropylene oxide each have an average molecular weight M_{w} of 200 to 4,000 g/mol, preferably 1,000 to 3,500 g/mol, more preferably 2,000 to 3,000 g/mol, as determined according to gel permeation chromatography using polystyrene as internal standard.

According to a thirty-fourth embodiment, the present invention relates to a composition according to embodiment 32 or 33, wherein the polypropylene oxide is present in a total amount of 0.01 to 1% by weight, preferably 0.05 to 0.5% by weight, very preferably 0.15 to 0.4%, based in each case on the total weight of the coating composition.

According to a thirty-fifth embodiment, the present invention relates to a composition according to any of the proceeding embodiments, wherein the coating composition additionally comprises at least one neutralizing agent, said neutralizing agent being preferably selected form the group consisting of inorganic bases, primary amines, secondary amines, tertiary amines and mixtures thereof, more particularly N,N′-dimethylethanolamine.

According to a thirty-sixth embodiment, the present invention relates to a composition according to embodiment 35, wherein the at least one neutralizing agent, preferably N,N′-dimethylethanolamine, is present in a total amount of 0.05 to 5 wt. %, preferably of 0.05 to 4 wt. %, more preferably of 0.05 to 1 wt. %, more particularly of 0.05 to 0.2 wt. %, based in each case on the total weight of the coating composition.

According to a thirty-seventh embodiment, the present invention relates to a composition according to any of the proceeding embodiments, wherein the coating composition additionally comprises at least one thickener, said thickener being preferably selected from the group of phyllosilicates, (meth)acrylic acid-(meth)acrylate copolymers, hydrophobically modified ethoxylated polyurethanes, hydrophobically modified polyethers, hydroxyalkylcelluloses, polyamides, and mixtures thereof, especially (meth)acrylic acid-(meth)acrylate copolymers and hydrophobically modified ethoxylated polyurethanes.

According to a thirty-eighth embodiment, the present invention relates to a composition according to embodiment 37, wherein the at least one thickener, more particularly (meth)acrylic acid-(meth)acrylate copolymers and hydrophobically modified ethoxylated polyurethanes, is present in a total amount of 0.015 to 3 wt. %, preferably of 0.03 to 2 wt. %, more preferably of 0.04 to 1 wt. %, more particularly of 0.05 to 0.7 wt. %, based in each case on the total weight of the coating composition.

According to a thirty-ninth embodiment, the present invention relates to a composition according to any of the proceeding embodiments, wherein the coating composition additionally comprises at least one crosslinking agent, said crosslinking agent being preferably selected from the group consisting of melamine-formaldehyde resins, free and/or blocked polyisocyanates, polycarbodiimides, and mixtures thereof, more particularly melamine-formaldehyde resins.

According to a fortieth embodiment, the present invention relates to a composition according to embodiment 39 wherein the at least one crosslinking agent, especially melamine-formaldehyde resin, is present in a total amount of 0 to 50 wt. % solids, preferably of 0 to 40 wt. % solids, more preferably of 0 to 35 wt. % solids, based in each case on the total binder content of the coating composition.

According to a forty-first embodiment, the present invention relates to a composition according to any of the proceeding embodiments, wherein the composition has a solids content of 10 to 60 wt. %, more preferably 12 to 55 wt. %, very preferably 15 to 50 wt. %, based in each case on the total weight of the coating composition and measured according to DIN EN ISO 3251 (June 2008).

According to a forty-second embodiment, the present invention relates to a composition according to any of the proceeding embodiments, wherein the composition comprises water in a total amount of 30 to 70% by weight, based on the total weight of the coating composition.

According to a forty-third embodiment, the present invention relates to a method for producing a multicoat paint system (M) on a substrate (S), comprising the following steps:
(1) optionally producing a cured first coating layer (S1) on the substrate (S) by application of a composition (Z1) to the substrate (S) and subsequent curing of the applied composition (Z1),
(2) producing a basecoat layer (BL2a) or at least two directly consecutive basecoat layers (BL2-x) directly on the first coating layer (S1) by application of an aqueous basecoat material (bL2a) directly to the first coating layer (S1) or directly consecutive application of at least two aqueous basecoat materials (bL2-x) directly to the first coating layer (S1),
(3) producing a clearcoat layer (C) directly on the basecoat layer (BL2a) or on the topmost basecoat layer (BL2-z) by application of a clearcoat material (cm) directly to the basecoat layer (BL2a) or to the topmost basecoat layer (BL2-z),
(4) jointly curing the basecoat layer (BL2a) and the clearcoat layer (C) or the basecoat layers (BL2-x) and the clearcoat layer (C),
   wherein
   the at least one basecoat material (bL2a) or at least one of the basecoat materials (bL2-x) comprises a composition according to any of embodiments 1 to 41.

According to a forty-fourth embodiment, the present invention relates to a method according to embodiment 43, wherein the substrate (S) is preferably selected from metallic substrates, plastic substrates, reinforced plastic substrates and substrates comprising metallic and plastic components, especially preferably from metallic substrates.

According to a forty-fifth embodiment, the present invention relates to a method according to embodiment 44, wherein the metallic substrates (S) is selected from iron, aluminum, copper, zinc, magnesium and alloys thereof as well as steel.

According to a forty-sixth embodiment, the present invention relates to a method according to any of embodiments 43 to 45, wherein the aqueous basecoat composition (bL2-z) comprises at least one hydroxy-functional polymer as binder, said at least one hydroxy-functional polymer being selected from the group consisting of a polyurethane, a polyester, a polyacrylate, copolymers thereof and mixtures of these polymers.

According to a forty-seventh embodiment, the present invention relates to a method according to any of embodiments 43 to 46, wherein the aqueous basecoat composition (bL2-z) comprises at least one coloring and/or effect pigment, more preferably at least one coloring and effect pigment.

According to a forty-eighth embodiment, the present invention relates to a method according to any of embodiments 43 to 47, wherein the aqueous basecoat (bL2-z) comprises at least one crosslinking agent selected from the group consisting of blocked polyisocyanates and/or aminoplast resins, preferably aminoplast resins.

According to a forty-ninth embodiment, the present invention relates to a method according to any of embodiments 43 to 48, wherein the joint curing (4) is carried at temperatures of 60 to 250° C., preferably 70 to 180° C., very preferably 80 to 160° C., for a duration of 5 to 60 minutes.

According to a fiftieth embodiment, the present invention relates to a multicoat paint system obtainable by a method according to any of embodiments 43 to 49.

### Examples

The present invention will now be explained in greater detail through the use of working examples, but the present invention is in no way limited to these working examples. Moreover, the terms “parts”, “%” and “ratio” in the examples denote “parts by mass”, “mass %” and “mass ratio” respectively unless otherwise indicated.

1. Methods of Determination:

1.1 Solids Content (Solids, Nonvolatile Fraction)

The nonvolatile fraction is determined according to DIN EN ISO 3251 (date: June 2008). It involves weighing out 1 g of sample into an aluminum dish which has been dried beforehand, drying it in a drying oven at 125° C. for 60 minutes, cooling it in a desiccator and then reweighing it. The residue relative to the total amount of sample used corresponds to the nonvolatile fraction. The volume of the nonvolatile fraction may optionally be determined if necessary according to DIN 53219 (date: August 2009).

1.2 Determination of Acid Number

The acid number is determined according to DIN EN ISO 2114 (date: June 2002), using “method A”. The acid number corresponds to the mass of potassium hydroxide in mg which is needed to neutralize 1 g of sample under the conditions stipulated in DIN EN ISO 2114. The reported acid number corresponds here to the total acid number indicated in the DIN standard, and is based on the solids content.

1.3 Determination of OH Number

The OH number is determined according to DIN 53240-2 (date: November 2007). In this method, the OH groups are reacted by acetylation with an excess of acetic anhydride. The excess acetic anhydride is subsequently cleaved to form acetic acid by addition of water, and the total acetic acid is back-titrated with ethanolic KOH. The OH number indicates the amount of KOH in mg (based on the solid) which is equivalent to the amount of acetic acid bound in the acetylation of 1 g of sample.

1.4 Determination of Number-Average and Weight-Average Molecular Weight

The number-average molecular weight (Mₙ) is determined by gel permeation chromatography (GPC) according to DIN 55672-1 (date: August 2007). Besides the number-average molecular weight, this method can also be used, moreover, for determining the weight-average molecular weight (Mₙ) and also the polydispersity d (ratio of weight-average molecular weight (Mₙ) to number-average molecular weight (Mₙ)). Tetrahydrofuran is used as eluent. The determination is made against polystyrene standards. The column material consists of styrene-divinylbenzene copolymers.

1.5 Production of Multicoat Paint Systems

Steel panels (30×50 cm, Chemetal) coated with a cured standard cathodic electrocoat material (Cathoguard 800, available from BASF Coatings GmbH) and a cured surfacer system (HR Anthrazit 121-71245-10, dry film thickness 25 to 30 μm, drying for 5 minutes at 23° C. and 5 minutes at 70° C., then curing for 10 minutes at 150° C.) were provided with an adhesive strip on one longitudinal edge, in order to be able to determine the film thickness differences after coating.

On these panels, the respective aqueous basecoat material WBC-C1, WBC-C2, WBC-I1 or WBC-I2 is applied electrostatically in wedge format and dried for 4 minutes at 23° C. and 10 minutes at 70° C. to obtain a first basecoat layer (BL2a) in a dry film thickness of 15 to 20 μm.

Afterwards, a ProGloss® two-component clearcoat material available commercially from BASF Coatings GmbH (FF99-0345) was applied atop the respective dried waterborne basecoat layer. The resulting clearcoat layer was flashed off at room temperature for 20 minutes. The respective waterborne basecoat layer and clearcoat layer were then jointly cured in an air circulation oven at 140° C. for 20 minutes. The film thickness of the cured clearcoat layer was constant over the whole panel (±1 μm), with a clearcoat film thickness of 40 to 45 μm.

1.6 Evaluation of Number of Pinholes and Pinholing Limit

The popping limit and pinholing limit were determined visually, by ascertaining the resulting film thickness of the basecoat film, increasing in wedge format, at which pops and pinholes, respectively, first occurred. In the case of the number of pinholes, furthermore, a determination was made of the number of pinholes which occurred on the coated metal panel with the edge length 30×50 cm.

1.7 Determination of Dry Film Thicknesses

The film thicknesses are determined according to DIN EN ISO 2808 (date: May 2007), method 12A, using the MiniTest® 3100-4100 instrument from ElektroPhysik.

2. Preparation of Aqueous Basecoat Materials

The following should be taken into account regarding the formulation constituents and amounts thereof as indicted in the tables hereinafter. When reference is made to a commercial product or to a preparation protocol described elsewhere, the reference, independently of the principal designation selected for the constituent in question, is to precisely this commercial product or precisely the product prepared with the referenced protocol.

Accordingly, where a formulation constituent possesses the principal designation “melamine-formaldehyde resin” and where a commercial product is indicated for this constituent, the melamine-formaldehyde resin is used in the form of precisely this commercial product. Any further constituents present in the commercial product, such as solvents, must therefore be taken into account if conclusions are to be drawn about the amount of the active substance (of the melamine-formaldehyde resin).

If, therefore, reference is made to a preparation protocol for a formulation constituent, and if such preparation results, for example, in a polymer dispersion having a defined solids content, then precisely this dispersion is used. The overriding factor is not whether the principal designation that has been selected is the term “polymer dispersion” or merely the active substance, for example, “polymer”, “polyester”, or “polyurethane-modified polyacrylate”. This must be taken into account if conclusions are to be drawn concerning the amount of the active substance (of the polymer).

2.1 Preparation of Color Pastes and Mica Slurry

2.1.1 Preparation of Carbon Black Paste P1

The carbon black paste P1 is prepared from 10.1 parts by weight of carbon black FW 2, 5 part by weight of a polyester prepared according example D, column 16, lines 37-59 of DE A 40 09 858 A1, 58.9 parts by weight of a binder dispersion prepared according to page 14, line 13 to page 15, line 13 of patent application WO 92/15405, 2.2 parts by weight of Pluriol® P900 (BASF SE), 8.4 parts by weight of deionized water, 7.8 parts by weight of an aqueous dimethylethanolamine solution (10 wt. % in deionized water) and 7.6 parts by weight of butyl glycol.

2.1.2 Preparation of Blue Paste P2

The blue paste P2 is prepared from 69.8 parts by weight of an acrylated polyurethane dispersion prepared according to WO 91/15528 (Binder dispersion A), 12.5 parts by weight Paliogen® blue L 6482, 1.5 parts by weight of an aqueous dimethylethanolamine solution (10 wt. % in deionized water), 1.2 parts by weight of Pluriol® P900 (BASF SE) and 15 parts by weight of deionized water.

2.1.3 Preparation of Mica Slurry

The mica slurry was prepared by mixing 1.5 parts by weight butyl glycol, 1.5 parts by weight of a polyester prepared according to example D, column 16, lines 37-59 of DE 4 009 858 A and 1.3 parts by weight of Mica Mearlin ext. Super Orange 339Z (Merck KGaA) with a stirring device.

2.2 Production of Aqueous Basecoat Materials WBC-C1 and WBC-C2 (Comparative)

The compounds listed in Table 1 under “aqueous phase” were mixed in the stated order to obtain an aqueous mixture. Additionally, the compounds listed in Table 1 under “organic phase” were mixed in the stated order to obtain an organic mixture. The organic mixture was added to the aqueous mixture while stirring and stirring was continued for 10 minutes. The composition is subsequently adjusted using deionized water and dimethylethanolamine to a pH of 8.0 and to a spray viscosity of 95 mPa*s under a shearing load of 1000 s⁻¹ as measured using a rotary viscometer (Rheomat RM 10 instrument from Mettler-Toledo) at 23° C.

TABLE 1
Compounds of aqueous basecoat materials WBC-C1 and WBC-2

| | | WBC-C1 | WBC-C2 |
|---|---|---|---|
| Aqueous | 3% Na—Mg phyllosilicate solution | 15.1 | 15.1 |
| phase | Deionized water | 22.0 | 22.0 |
| | Butyl glycol | 4.80 | 4.80 |
| | Polyurethane dispersion ¹⁾ | 27.4 | 27.4 |
| | Daotan ® TW 6464/36WA (supplied by Allenx) | 4.00 | 4.00 |
| | Maprenal ® MF 909 (supplied by Ineos) | 4.80 | 4.80 |
| | Polyester ²⁾ | 4.80 | 4.80 |
| | dimethylethanolamine solution (10 wt. % in | 0.95 | 0.95 |
| | deionized water) | | |
| | Polyurethane poly(meth)acrylate dispersion ³⁾ | 3.00 | 3.00 |
| | 2-Ethylhexanol | 1.90 | 1.90 |
| | TMDD (supplied by BASF) | 1.00 | 1.00 |
| | Rheovis ® PU 1250 (50% solution, supplied | 0.20 | 0.20 |
| | by BASF SE) | | |
| | Rheovis ® AS S130 (3% solution, supplied | 0.29 | 0.29 |
| | by BASF SE) | | |
| | Carbon black paste P1 | 5.20 | 5.20 |
| | Blue paste P2 | 2.10 | 2.10 |
| | Compound of formula (1) ⁴⁾ | 2.00 | — |
| | Compound of formula (1) ⁵⁾ | — | 2.00 |
| Organic | Mixture of 2 different aluminum effect | 0.05 | 0.05 |
| phase | pigments (supplied by Altana-Eckart) | | |
| | Butyl glycol | 0.05 | 0.05 |
| | Polyester ²⁾ | 0.04 | 0.04 |
| | Mica slurry | 0.32 | 0.32 |

¹⁾ prepared according to WO 92/15405 (page 14, line 13 to page 15, line 28),
²⁾ prepared according to example D, column 16, lines 37-59 of DE 4 009 858 A
³⁾ prepared according to DE 19 948 004 B4 (page 27, example 2), solid content was adjusted with deionized water to 32.5%
⁴⁾ a = 0, R₂ = CH₃, b = 1, R₁ = *—(CH₂)₃—CH₃
⁵⁾ a = b = 1, R₂ = H, R₁ = *—(CH₂)₂—CH₃

2.3 Production of Aqueous Basecoat Material WBC-I1 (Inventive)

The inventive aqueous coating material WBC-I1 was prepared by addition of 0.5 parts by weight of Agitan® 352 (contains 45 to 55% by wt. of a mixture of mono-, di- and triglycerols based on palmitic acid, stearic acid, linoleic acid and oleic acid as well as fumed silica) to 99.5 parts by weight of aqueous basecoat material WBC-C1 under stirring.

2.4 Production of Aqueous Basecoat Material WBC-I2 (Inventive)

The inventive aqueous coating material WBC-I2 was prepared by addition of 0.5 parts by weight of Agitan® 352 (contains 45 to 55% by wt. of a mixture of mono-, di- and triglycerols based on palmitic acid, stearic acid, linoleic acid and oleic acid as well as fumed silica) to 99.5 parts by weight of aqueous basecoat material WBC-C2 under stirring.

3. Pinholing Limit and Number of Pinholes

The pinholing limit and the number of pinholes of the prepared multilayer coatings (see point 1.5) was determined as described in point 1.6. The obtained results are shown in Table 2.

TABLE 2
pinholing limit and pinholing number of multilayer coatings
prepared by using WBC-C1, WBC-C2, WBC-11 and WBC-12

| Aqueous basecoat | Pinholing | Number of |
|---|---|---|
| material | limit [μm] | pinholes |
| WBC-C1 (comparative) | 13 | >20 |
| WBC-11 (inventive) | up to 25 | 0 |
| WBC-C2 (comparative) | 11 | >30 |
| WBC-12 (inventive) | up to 25 | 0 |

The use of a combination of triacyl glycerols (b) and fumed silica (c) in the inventive aqueous pigmented basecoat compositions (WBC-I1 and WBC-I2) leads to a significantly increased pinholing limit and decreased number of pinholes as compared to pigmented aqueous basecoat compositions not comprising triacyl glycerols and fumed silica (WBC-C1 and WBC-C2).

1. A pigmented aqueous coating composition comprising
(a) at least one binder,
(b) at least one ester of glycerol with an unsaturated or saturated C₆-C₃₀ aliphatic monocarboxylic acid in a total amount of 0.01 to 1% by weight, based on the total weight of the coating composition, and
(c) at least one silica compound.

2. The pigmented aqueous coating composition according to claim 1, wherein the at least one binder is present in a total amount of 2 to 60 wt. % solids based on the total binder content of the coating composition.

3. The pigmented aqueous coating composition according to claim 1, wherein the at least one binder is selected from the group consisting of polyurethanes, polyesters, poly(meth)acrylates, copolymers thereof and mixtures of these polymers.

4. The pigmented aqueous coating composition according to claim 1, wherein the acid component of the triacyl glycerol is selected from the group consisting of palmitic acid, stearic acid, linoleic acid and oleic acid and mixtures thereof.

5. The pigmented aqueous coating composition according to claim 1, wherein the at least one ester of glycerol with an unsaturated or saturated C₆-C₃₀ aliphatic monocarboxylic acid is present in a total amount of 0.05 to 0.5% by weight based on the total weight of the coating composition.

6. The pigmented aqueous coating composition according to claim 1, wherein the at least one silica compound is fumed silica.

7. The pigmented aqueous coating composition according to claim 1, wherein the at least one silica compound is present in a total amount of 0.001 to 1% by weight based on the total weight of the coating composition.

8. The pigmented aqueous coating composition according to claim 1, wherein the composition further comprises at least one compound of general formula (I) 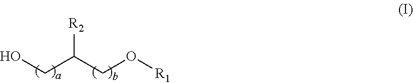
wherein
R₁, is a linear or branched C₁-C₁₀ alkyl group,
R₂ is hydrogen or a linear or branched C₁-C₁₀ alkyl group,
a is an integral number of 0 to 10 and
b is an integral number of 1 to 10.

9. The pigmented aqueous coating composition according to claim 8, wherein the residue R₁ in general formula (I) is a linear or branched C₂-C₈ alkyl group.

10. The pigmented aqueous coating composition according to claim 8, wherein the residue R₂ in general formula (I) is hydrogen or a linear C₁-C₄ alkyl group.

11. The pigmented aqueous coating composition according to claim 8, wherein a in general formula (I) is an integral number of 0 or 1.

12. The pigmented aqueous coating composition according to claim 8, wherein b in general formula (I) is an integral number of 1 to 8.

13. The pigmented aqueous coating composition according to claim 8, wherein the compound of general formula (I) is present in a total amount of 0.1 to 15% by weight based on the total weight of the coating composition.

14. A method for producing a multicoat paint system (M) on a substrate (S), comprising the following steps:
(1) optionally producing a cured first coating layer (S1) on the substrate (S) by application of a composition (Z1) to the substrate (S) and subsequent curing of the applied composition (Z1),
(2) producing a basecoat layer (BL2a) or at least two directly consecutive basecoat layers (BL2-x) directly on the first coating layer (S1) by application of an aqueous basecoat material (bL2a) directly to the first coating layer (S1) or directly consecutive application of at least two aqueous basecoat materials (bL2-x) directly to the first coating layer (S1),
(3) producing a clearcoat layer (C) directly on the basecoat layer (BL2a) or on the topmost basecoat layer (BL2-z) by application of a clearcoat material (cm) directly to the basecoat layer (BL2a) or to the topmost basecoat layer (BL2-z), and
(4) jointly curing the basecoat layer (BL2a) and the clearcoat layer (C) or the basecoat layers (BL2-x) and the clearcoat layer (C),
wherein
the at least one basecoat material (bL2a) or at least one of the basecoat materials (bL2-x) comprises a composition according to claim 1.

15. A multicoat paint system obtainable by the method according to claim 14.

16. The pigmented aqueous coating composition according to claim 1, wherein the at least one binder is present in a total amount of 3 to 50 wt. % solids based on the total binder content of the coating composition.

17. The pigmented aqueous coating composition according to claim 1, wherein the at least one binder is present in a total amount of 5 to 45 wt. % solids based on the total binder content of the coating composition.

18. The pigmented aqueous coating composition according to claim 1, wherein the at least one ester of glycerol with an unsaturated or saturated C₆-C₃₀ aliphatic monocarboxylic acid is present in a total amount of 0.15 to 0.4% by weight based on the total weight of the coating composition.

19. The pigmented aqueous coating composition according to claim 1, wherein the at least one silica compound is present in a total amount of 0.005 to 0.5% by weight based on the total weight of the coating composition.

20. The pigmented aqueous coating composition according to claim 1, wherein the at least one silica compound is present in a total amount of 0.01 to 0.1% by weight, based on the total weight of the coating composition.
